(19) United States
(12) Patent Application Publication
(10) Pub. No.: US 2009/0108969 A1
(43) Pub. Date: Apr. 30, 2009

(54) APPARATUS AND METHOD FOR TRANSCRANIAL AND NERVE MAGNETIC STIMULATION

(75) Inventors: James Rae Sims, Los Alamos, NM (US); Charles A. Swenson, Los Alamos, NM (US); Curtt N. Ammerman, Los Alamos, NM (US); Josef B. Schillig, Los Alamos, NM (US)

Correspondence Address: JOHN P. O'BANION;O'BANION & RITCHEY LLP, 400 CAPITOL MALL SUITE 1550, SACRAMENTO, CA, 95814, US

(73) Assignee: LOS ALAMOS NATIONAL SECURITY, Los Alamos, NM (US)

(21) Appl. No.: 11/932,990

(22) Filed: Oct. 31, 2007

(51) Int. Cl. H01F 5/00

(52) U.S. Cl. 335/300

(57) ABSTRACT

An electromagnet coil comprising Litz wire windings and power leads without break or interruption is cooled by a perfluorinated liquid by sensible and phase change heat transfer in a closed system. The electromagnet coil may be housed in a pentagonal or hexagonal pressure vessel to allow high packing densities in an array or helmet configuration. The helmet is then lowered over a human cranium for transcranial electromagnetic stimulation. The Litz wire windings reduce the power and voltages required for operation, yet allow production of over 2 T of accurately directed magnetic pulses for direct nerve or neuron stimulation. The perfluorinated liquid maintains the temperature of the helmet to less than 35-40° C., ensuring a comfortable temperature device for a human test subject. A utility cable connects the helmet to an external cooling unit and an external power supply.

### STATEMENT REGARDING FEDERALLY SPONSORED RESEARCH OR DEVELOPMENT

This invention was made with Government support under Contract No. DE-AC52-06NA25396 awarded by the U.S. Department of Energy. The Government has certain rights in this invention.

### CROSS-REFERENCE TO RELATED APPLICATIONS

Not Applicable

### BACKGROUND OF THE INVENTION

1. Field of the Invention

This invention pertains generally to the cooling of high power electromagnets, and more particularly to the cooling and packaging of high power pulsed electromagnets for electromagnetic field induction in biological axons and ganglions.

2. Incorporation by Reference

Each of the following documents which is referred to herein using numbers inside square brackets (e.g., [1]) are incorporated herein by reference in its entirety:

1. A theoretical calculation of the electric field induced in the cortex during magnetic stimulation. Electroencephalography and clinical Neurophysiologyl8:47 56. Rudin D O and Eisenman G. (1954).

2. A model for the polarization of neurons by extrinsically applied electric fields. Biophysical Journal 50:1139 1156. Wada J, Rasmussen T. (1960).

3. Suppression of visual perception by magnetic coil stimulation of human occipital cortex. EEGCNP 74:458 462. Artola A, Brocher S, Singer W. (1990).

4. Slow magnetic stimulation of prefrontal cortex in depression and schizophrenia. Progress in Neuro-Psychopharmacology and Biological Psychiatry 21:105 110. Gerloff C, Corwell B, Chen R, Hallett M, Cohen L G (1997).

5. Stimulus intensity and coil characteristics influence the efficacy of rTMS to suppress cortical excitability. Clinical Neurophsiology 117 2292-2301. Lang N, Harms J, Weyh T, Lemon R, Paulus W, Rothwell J, Hatwig S. (2006).

6. Product Manual, 1987, Fluorinert Electronic Liquids, Commercial Chemical Products Division, 3M Company, St. Paul, Minn.

7. Pool Boiling of High-Frequency Conductors. American Society of Mechanical Engineers, Heat Transfer Division, (Publication) HTD; 2001; v.369, no.2, p.91-98.

Conference: ASME International Mechanical Engineering Congress and Exposition. Wright S, Konecni S, Ammerman C, Sims J. (2001).

8. Multiphase Cooling of High Frequency Conductors Encased in a Porous Medium. Proceedings of the ASME Summer Heat Transfer Conference; Publication HT2003-47492, 2003; v.2003, p.687-699. Morgan N, Ammerman C, Sims J, Konecni S, Wilson J. (2003).

9. Coil assemblies for magnetic stimulators, U.S. Pat. No. 6,179,770; Jan. 30, 2001, Stephen Mould.

10. Method and apparatus for magnetically stimulating neurons, U.S. Pat. No. 4,940,453; Jul. 10,1990, John A. Cadwell.

11. Magnetic stimulator with skullcap-shaped coil, U.S. Pat. No. 5,116,304; May 26,1992, John A. Cadwell.

12. Apparatus and methods for delivery of transcranial magnetic stimulation, U.S. Pat. No. 7,087,008; Aug. 8, 2006, Peter Fox.

3. Description of Related Art

Transcranial magnetic stimulation (TMS) is the use of trains of directed, magnetic field pulses to stimulate and affect brain and nerve function by means of the induced electric fields produced within brain and nerve tissue by rapidly changing magnetic fields [1,2]. The magnetic and electrical properties of the scalp, skull, cerebral fluid, brain, nerve and other body tissues permit the relatively efficient transmission of pulsed magnetic fields into the interior of the head, trunk and limbs by means of pulsed electromagnetic coils located outside of the body. Research indicates that magnetic stimulation may be used to enhance, degrade and measure/gage mental and nervous functions

[3]. Further, there are indications that magnetic stimulation may have clinical and therapeutic value in the treatment of schizophrenia, depression and other mental illnesses [4]. It has been proposed that arrays of these coils be used to stimulate different areas of the brain simultaneously for both research and clinical purposes. These arrays would be made in the form of a helmet or shell around the head or panels for use against other parts of the body. There may be further highly speculative uses of the transcranial magnetic stimulation effect for purposes of enhancement or degradation of mental performance and direct stimulation input to the brain or nervous system elsewhere in the body. Pulsed magnet coils currently in use for TMS are large (90 mm in span across diameters or larger), and are solidly impregnated and hence cooled by solid conduction to the coil housing which is then air cooled.[5] To generate the required effect, a rapidly rising, high level magnetic field must be generated and projected by the coil. Generating this field using traditional methods requires a high electrical voltage (9 kV) to drive the coil. Attempts to actively cool the TMS coils using water based or dielectric oil coolants have been frustrated by both dangers to the test subjects (due to potential electrical shock hazards and high temperatures due to poor cooling) and inefficiency of heat transfer media (such as insulating oils that would not undergo phase change during normal operation, and hence had only low heat capacity). There is also a sharp report or noise when the coils are energized which can confuse the evaluation of the effect of magnetic stimulation.

### BRIEF SUMMARY OF THE INVENTION

An aspect of the invention is a fluid cooled electromagnet that comprises: an electromagnet that has a central region; and a means for cooling the electromagnet. The means for cooling the electromagnet may comprise a refrigerant that is forced through the electromagnet, wherein the refrigerant is substantially a dielectric. The refrigerant may be substantially comprised of Fluorinert™ FC-87™, which has a boiling point of about 30° C., or about 86° F.

The means for cooling the electromagnet may comprise: a housing, where the housing comprises: an inlet that flows an externally cooled refrigerant to the central region; an outlet that receives refrigerant that has flowed through the electromagnet; and an electrically non-conducting pressure vessel that entirely encloses the electromagnet, that opens to the inlet and outlet. Here, the pressure vessel does not substantially affect a magnetic field generated by the electromagnet when energized. Additionally, the pressure vessel has sufficient strength to contain a pressure of the refrigerant comprising: an inlet pressure as the refrigerant enters the inlet; a phase change pressure, generated as the refrigerant undergoes a phase change from liquid to gas through boiling heat transfer; and an outlet backpressure as the refrigerant flows through the outlet.

Another aspect of the invention is that the fluid cooled electromagnet is wound with a Litz wire to form an electromagnet coil winding. The electromagnet coil winding may be supported by a frame, and may also comprise multiple layers. The electromagnet coil winding may also comprise multiple turns.

The fluid cooled electromagnet may also comprise: a current source Iᵢₙ comprised of the Litz wire of which the electromagnet is wound; and a current sink Iₒᵤₜ comprised of the Litz wire of which the electromagnet is wound. The current source Iᵢₙ, current sink Iₒᵤₜ, and the electromagnet coil winding may consist of the same uninterrupted continuous Litz wire without any splice, joint, or other means for attaching.

The fluid cooled electromagnet may be one of an array of fluid cooled electromagnets that can programmably direct magnetic fields into a human cranium. The fluid cooled electromagnet may also direct magnetic fields into nerves.

The fluid cooled electromagnet may comprise: a non-ferromagnetic core. Here, the non-ferromagnetic core may be an “air core”. Alternatively, the fluid cooled electromagnet may comprise: a ferromagnetic core. The ferromagnetic core ferromagnetic core is preferred for lower frequency operation as the skin depth at these frequencies better matches the physical dimensions of the core, as the core may magnetically respond sufficiently and rapidly through its thickness due a match between dimensions of the core and skin depth at the operating frequency to effect enhancement of the magnetic field being produced, and may also be adequately cooled in such an arrangement.

A still further aspect of the invention is a method for transcranial magnetic stimulation that comprises: providing an electromagnet coil; flowing a dielectric refrigerant over the electromagnetic coil to cool the electromagnetic coil; and directing a magnetic pulse from the electromagnet coil to a human or other mammalian cranium. Here, the dielectric refrigerant may most preferably be a perfluorocarbon. The directing of the magnetic pulse from the electromagnet coil to the human cranium step may effect transcranial magnetic stimulation.

In another embodiment of the invention, a transcranial magnetic stimulator may comprise: an electromagnet wound of a Litz wire; a set of power leads that connect to the electromagnet comprised of the same Litz wire without splice or interruption; and a perfluorocarbon in contact with the Litz wire for substantially the entire length of the Litz wire; whereby the Litz wire is cooled by the perfluorocarbon when the electromagnet is energized. Here, the transcranial magnetic stimulator may comprise: an external cooling unit that cools the perfluorocarbon that is heated due to heat dissipated by the Litz wire and ferromagnetic core when the electromagnet is energized. The external cooling unit may be a closed system that prevents loss of the perfluorocarbon

The transcranial magnetic stimulator may also comprise: a computer controlled power supply that energizes the electromagnet with a waveform directed by a computer control, wherein: the electromagnet may continuously produce an external directed magnetic field in excess of 2 T without thermally induced damage.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1A is a cross sectional perspective view of a high power, high duty cycle pulsed electromagnet for nerve or transcranial magnetic field stimulation showing refrigerant cooling paths through the electromagnet coil windings.

FIG. 1B is a cross sectional perspective view of the device of FIG. 1A, showing in detail the Iᵢₙ and Iₒᵤₜ and coil winding wiring.

FIG. 1C is a perspective view of a frame used in the device of FIG. 1A for forming and supporting the electromagnet coil winding.

FIG. 2 is a perspective drawing of one potential application of the high power, high duty cycle pulsed electromagnet for transcranial magnetic field stimulation.

FIG. 3A is a cross-sectional view of a single concentric power and cooling cable.

FIG. 3B is a cross-sectional view of a coextruded parallel power and cooling cable.

FIG. 3C is a cross section of a simplified Litz wire with bare individual conductors.

FIG. 3D is a cross section of a simplified Litz wire comprised of individual strands of conductor that are coated with an insulator.

FIG. 3E is a cross section of one embodiment of the utility cable shown in detail.

FIG. 4 is a top view of a prior art figure-of-eight transcranial magnetic stimulation coil. During operation, the figure-of-eight coil would be positioned over the scalp. This device has no provision for active cooling.

### DETAILED DESCRIPTION OF THE INVENTION

### Definitions

The following definitions are provided to facilitate an understanding of the terminology used herein. It is intended that those terms not present in these Definitions be given their plain meaning as understood by those persons having ordinary skill in the art.

Fluorinert™ means the trademarked brand name for the line of electronics coolant liquids sold commercially by 3M. It is an electrically insulating, inert perfluorocarbon fluid which is used in various cooling applications but is mainly for cooling electronics. Different molecular formulations are available with a variety of boiling points, allowing it to be used in “single phase” applications where it remains a fluid, or for “two-phase” applications where the liquid boils to remove additional heat via evaporative cooling. An example of one of the formulations 3M uses would be for instance, FC-72, or perfluorohexane (C₆F₁₄) which is used for low temperature heat transfer applications due to its boiling point of 56° C. Another example is FC-75, perfluoro(2-butyl-tetrahydrofurane).

FC-87 means a specific 3M product of Fluorinert with a boiling point of about 30° C. This product contains perfluorocarbons comprising C₅-C₁₈.

Litz wire is a shortened form of Litzendraht wire, which is a bundle of multiple insulated and appropriately positioned strands that has lower ac resistance than a single strand of the same cross sectional area. This is due to the reduction of the skin effect (i.e. the current of an ac signal doesn't penetrate all the way into a conductor), but is limited by the mutual coupling between the strands. High frequency currents are known to flow substantially on the surface, resulting from the “skin” effect. Thus, a single thick conductor flowing a high frequency current results in much of the wire not being used, as the current flows only on the skin, or outermost surface. The limitation of mutual coupling is reduced by appropriately positioning or weaving the strands so that each individual strand occupies every possible position in the bundle periodically along the length of the bundle. The positioning or weaving equalizes flux linkages and hence reactances causing the current to divide more uniformly between strands.

### Description

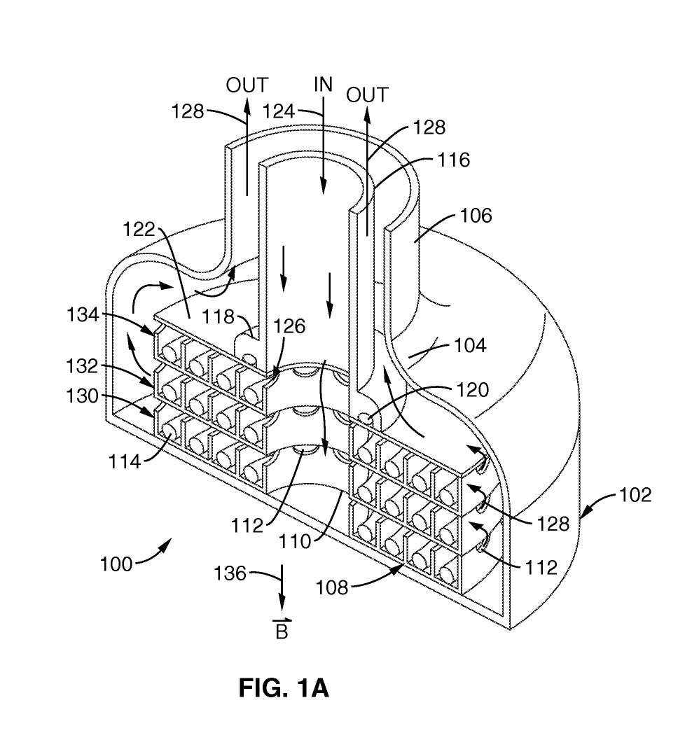

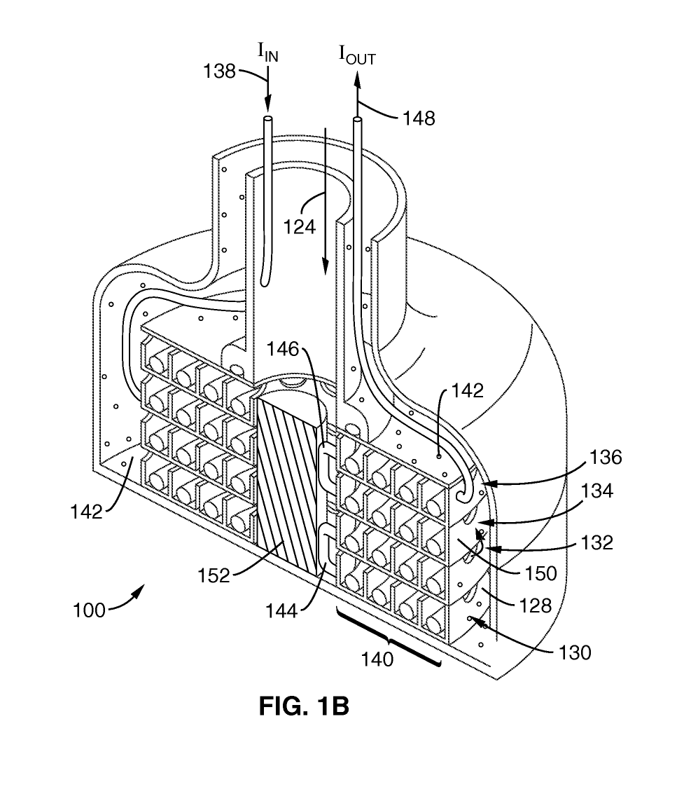

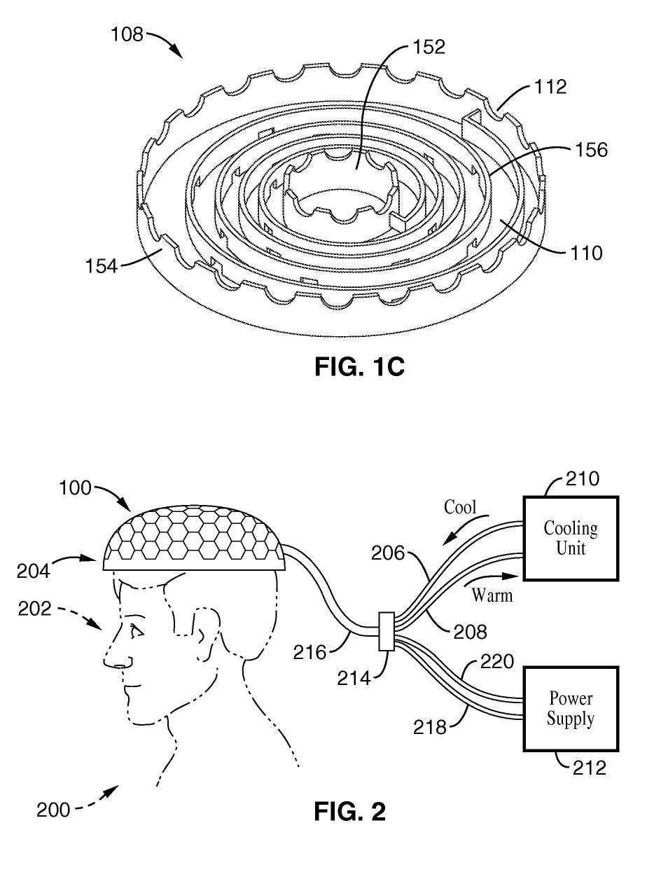

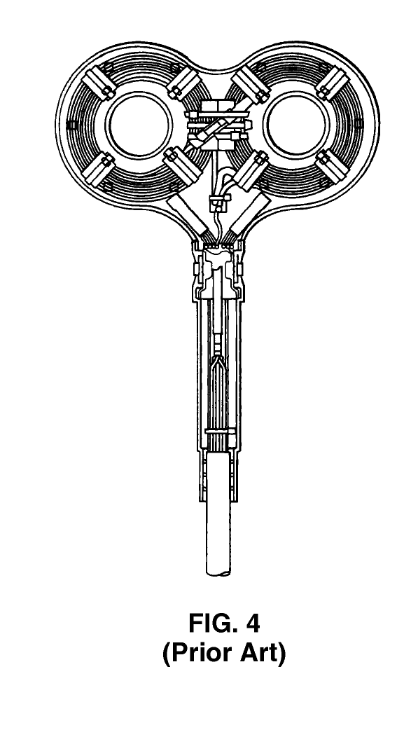

Referring more specifically to the drawings, for illustrative purposes the present invention is embodied in the apparatus generally shown in FIG. 1A through FIG. 4. It will be appreciated that the apparatus may vary as to configuration and as to details of the parts, and that the method may vary as to the specific steps and sequence, without departing from the basic concepts as disclosed herein.

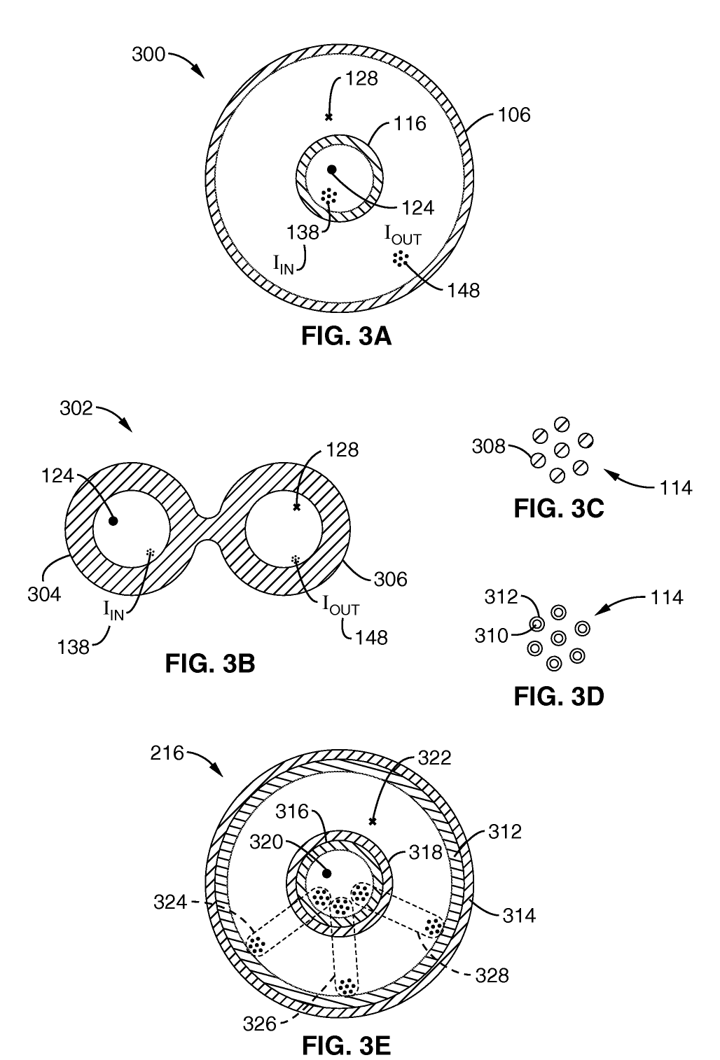

Refer now to FIG. 1A, a pulsed, high field, high duty cycle, cooled electromagnet coil 100 for transcranial and nerve magnetic stimulation. An outer circumference pressure vessel 102 necks down 104 to a smaller diameter outflow tube 106. A frame 108 is disposed within the pressure vessel 102. The frame 108 has a base 110, and a plurality of apertures 112. Litz wire 114 is wound within the frame 108. The electromagnet coil 100 may comprise a spiral wound pancake or helically wound multiple layer and multiple turn pulsed electromagnetic, non-ferromagnetic core (“air core”) coil of copper or silver (or other high electrical conductivity metals) Litz wire 114 conductor (a typical Litz wire would be New England Wire Technologies copper filament 3×35/36). An inner fluid supply line 116 may be disposed within the larger diameter outflow tube 106 or alternatively the may be two separate or coextruded parallel tubes (shown later in FIGS. 3A and 3B). The inner fluid supply line 116 may have a land 118 within which an O-ring 120 or other suitable gasket seals to an upper frame 122. Externally cooled refrigerant 124 flows down the inner fluid supply line 116, and ultimately forms radial flow lines 126 that enter the plurality of apertures 112 found in the frames 108. The radial flow lines 126 flow through the frames 108 and around the Litz wire 114, whereby the Litz wire 114 is cooled by the forced refrigerant flow to result in a warmed, mixed phase refrigerant exhaust flow 128. The exhaust flow 128 exits between the outflow tube 106 and the exterior diameter of the inner fluid supply line 116. A layer 130 of Litz wire 114 may be wound on a frame 108. A second such layer 132 is a method of increasing field strength of the electromagnet coil 100. An additional layer 134 may be repeated as needed to provide the necessary projected magnetic field strength 136.

Pressure vessel 102 has been shown in FIG. 1A as radially symmetric about its center, but the pressure vessel may instead take on a hexagonal or pentagonal geometry as desired for increased ability to closely pack electromagnet coils 100 adjacently (in very close proximity, or even touching) with little loss of space.

The polygon shaped (such as hexagonal and pentagonal) tapered coil housing shape permits a large number of coils to be arranged about the head for better resolution and precision of magnetic field generation. The interior corners of the vertices of the hexagonal and pentagonal housings provide room for coil power leads and return flow of coolant while allowing the coils to be arranged in dense patterns. The small size of the coils in the present invention will also enable the construction of arrays of coils compact enough for a subject or patient to wear within medical imaging machines. It is also projected that the fluid coolant and construction used in the present invention will provide some damping or muffling of the acoustic coil noise generated when the coil is operated.

The arrangement of externally cooled refrigerant 124 flowing from the electromagnet coil 100 bore and then through a combination of radial apertures 112 and circumferential paths through and around the winding layers 130, 132, 134 causes the coolest of the externally cooled refrigerant 124 to make initial contact with the hotter section of Litz wire 114 at the smallest diameter of the electromagnet coil 100. In high field, rapidly pulsed coils, heat production is a strong function of the background magnetic field level experienced by an individual turn of wire; the turns at the center of the coil are exposed to the highest magnetic fields.

The Litz wire 114 is supported and located by the frame 108, which may be made of a non-metallic, insulating material and cooled with a forced flow of dielectric, perfluorinated, low boiling point (˜30 degrees C.), liquid refrigerant such as Fluorinert FC-87™ [6,7]. The forced coolant flow is directed in a radial outward and circumferential manner through the windings by means of patterns of holes and slots 112 in the frame 108. Warmed coolant (liquid and vapor phase) is exhausted 128 on the radius of the coil and returned to a central condenser via the utility or power cable as later shown in FIG. 2. Other electromagnet coil 100 coolant flow patterns are also envisioned depending upon coil winding details to achieve consistent cooling of the Litz wire 114 during its entire operating length.

Refer now to FIG. 1B, where more details of the electromagnet coil 100 are shown. Here, the Litz wire input conductor Iᵢₙ 138 enters the coil winding 140 at an outer perimeter 142. Inner layer crossovers 144 and 146 continue the windings of frames 108 between layers 130-132 and between layers 132-134. The Litz wire output conductor Iₒᵤₜ 148 exits the coil winding 140 at another outer perimeter 150. The power leads are placed on the outer diameter of the coil to reserve the coil bore for coolant flow to the coil turns at the center and to reduce magnetic loading on the power leads. The power leads Iᵢₙ 138 and Iₒᵤₜ 148 are also made from Litz wire and are a continuation of the coil winding (there are no splices) and pass back through a utility power cable to the pulsed power source (shown later in FIG. 2).

While the electromagnet coil 100 is shown with nothing but refrigerant in the center in FIG. 1A's “air core” case, for low frequency pulsed operation a ferromagnetic core 152 may be used in the center of the coil winding 140 to make an “iron core” implementation. In the iron core implementation, the ferromagnetic core 152 is cooled by the externally cooled refrigerant 124. In higher frequency usage, the ferromagnetic core 152 may have channels and other apertures permitting increased cooling by the forced flow of the externally cooled refrigerant 124.

Refer now to FIG. 1C, which is a perspective view of a single frame 108 without any Litz wire (114) being shown for clarity. The frame 108 is basically disk shaped about the base 110, with an inner diameter 152 and an outer diameter 154. Between the inner diameter 152 and the outer diameter 154 is a support wall 156 that is between about ½ and ¾ of the thickness of the Litz wire (not shown 114), so as to provide lateral retention to the Litz wire (not shown 114) when energized with heavy currents. The support wall 156 spirals in from the outer diameter 154 to the inner diameter 152, thereby providing continuous support of the Litz wire (not shown 114) as it enters from the outer diameter 154 and exits from the inner diameter 152. Alternating layers 130,132, and 134 of frames 108 will be wrapped in the same sense so that a magnetic field 136 \vec{B} is projected out from the electromagnet coil 100 (both shown in FIG. 1A). The support wall 156 spirals here are shown as so large as to only allow three windings. This has only been done for clarity, and any number of windings may be used as desired with the support wall 156 spirals adjusted appropriately.

Each frame 108 is constructed of a dielectric material that maintains sufficient mechanical strength to support the electromagnet coil 100 during high repetition, high current operation, while being cooled by the externally cooled refrigerant 124. Most likely, the frame 108 would most economically be made by injection molding of an appropriate thermoplastic, such as polycarbonate, acrylonitrile butadiene styrene (ABS), HDPE, or nylon. If the electromagnetic coil 100 is to see continuous high repetition rate operation, then it may be preferable to use polytetrafluoroethylene due to its very low dissipation factor. These materials would likely have sufficient dielectric properties in this application, so long as no carbon fibers were added as an admixture in the process of their molding.

Refer now to FIG. 2, which is a drawing of one potential application of the high power, high duty cycle pulsed electromagnet 100 for nerve or transcranial magnetic field stimulation 200. In this drawing, a subject 202 has placed over their head a helmet 204 comprising an array of individual hexagonal and pentagonal electromagnetic coils 100. Here, within the helmet 204, and not shown, are various bundling and routing arrangements of power lines for each individual electromagnet coil 100, as well as a combination of the cool refrigerant 206 and the warmed exhaust refrigerant 208. Cooling unit 210 provides for cooling the warmed exhaust refrigerant 208 and converting it once again into cool refrigerant 206. Power supply 212 provides a plurality of individual connections to each of the electromagnet coils 100.

Umbilical junction 214 separates from a combination utility cable 216 the cool refrigerant 206, the warmed exhaust refrigerant 208, and the two Litz wire conductors (Iᵢₙ 138 and Iₒᵤₜ 148 of FIG. 1B) each electromagnet coil 100 in the array helmet 204. Separated Litz wires pass as bundles 218 and 220 (or more, as needed) to the computer controlled (not shown) power supply 212.

The utility cable 216 is made of nested and bundled co-extruded flexible polymer tubing with several independent and isolated passageways to provide support, electrical isolation and cooling of power leads, and passage and isolation of cooled refrigerant 206 and warmed exhaust refrigerant 208. The electromagnet coil 100 has been designed to produce a small (30 mm diameter), high field (2 Tesla at the coil projection face), high duty cycle high frequency, long service life (1000 hours), safely cooled, modular pulsed electromagnet coil that may be arranged in compact, efficient spherical or shell like and planar or curved panel arrays or as shown in FIG. 2 a helmet 204 configuration.

Refer now to FIG. 3A, which is a cross-sectional view of a single power and cooling cable 300 that is comprised of components seen previously in FIGS. 1A and 1B. An inner fluid supply line 116, where the high voltage power lead Iᵢₙ 138 is also contained, may be disposed within the larger diameter outflow tube 106. Externally cooled refrigerant 124 flows (•—out of the figure) through the inner fluid supply line 116. A warmed, mixed phase refrigerant exhaust flow 128 exits (x—into the figure) between the interior diameter of the outflow tube 106 and the exterior diameter of the inner fluid supply line 116, where the high voltage power lead Iₒᵤₜ 148 is also contained.

Refer now to FIG. 3B, which is a cross-sectional view of a coextruded parallel power and cooling cable 302. An externally cooled input fluid supply line 304 may be disposed parallel to an outflow tube 306. Externally cooled refrigerant 124 flows (•—out of the figure) through the externally cooled input fluid supply line 304. A warmed, mixed phase refrigerant exhaust flow 128 exits (x—into the figure) through the outflow tube 306. High voltage power lead Iᵢₙ 138 passes through the interior of input fluid supply line 304 where it is cooled by single phase liquid refrigerant. High voltage lead Iₒᵤₜ 148 passes through the interior of the outflow tube 306, where it is cooled by the mixed phase refrigerant exhaust flow 128.′

Refer now to FIG. 3C, which is a cross section of a simplified Litz wire 114. Here, bare individual conductors 308 comprise the Litz wire 114. This is one form of Litz wire 114, however, not a preferred form.

Refer now to FIG. 3D, which is a cross section of a simplified Litz wire 114. Here, the Litz wire 114 is comprised of individual strands of conductor 310 that are coated with an insulator 312. This insulator 312 permits improved high frequency performance of the Litz wire 114.

It should be noted that in both FIGS. 3C and 3D that only seven conductor strands were used simply for clarity. In actuality, the Litz wires may be comprised of 10's to even 100 strands. The Litz wire 114 described earlier in this patent was comprised of 35 strands.

Refer now to FIG. 3E, which is a cross section of one embodiment of the utility cable 216, shown in detail. Here, the utility cable 216 begins with a relatively large diameter utility outflow tube 312, which may be further coated on its outer diameter with polyimide or other insulation coating 314. An inner utility fluid supply line 316 which may be further coated on its outer diameter with polyimide or other insulation coating 314, and may be disposed within the relatively larger diameter utility outflow tube 312. Externally cooled utility refrigerant 320 flows (•—out of the figure) through the inner utility fluid supply line 316. A warmed, mixed phase refrigerant utility exhaust flow 322 exits (x—into the figure) between the interior diameter of the utility outflow tube 312 and the exterior diameter of the inner utility fluid supply line 316, where one lead each of high voltage leads pairs 324, 326, and 328 are also contained. The other leads of high voltage lead set pairs 324, 326 and 328 are contained in the interior of inner utility supply line 316. These three sets of high voltage power lead pairs 324, 326, and 328 provide power connections to three of the electromagnet coils 100 previously shown in FIG. 1A.

### Advantages

Magnetic transcranial stimulation depends on the electrical effect of a rapidly changing magnetic field

$$\frac{d \vec{B}}{d t}$$

within the brain. There is a requirement to precisely direct these fields. Further there is need to generate trains of tailored, rapidly rising combined pulses on a continuing basis and move the magnetic field maximums of these combined pulses rapidly to different parts of the brain. This invention provides for small coils (relative to 90 mm pancakes in present use) capable of safely producing high fields, and that can be mounted in a closely arranged array around the head or in a compact panel. The small size of the coils decreases inductance, which permits greater values of

$$\frac{d \vec{B}}{d t}$$

at lower voltages that consequently reduces energy requirements. The use of appropriately sized and textured non-impregnated or bonded (supported in a passageway with adequate open cross-section for coolant flow) Litz wire for windings significantly reduces eddy current and other high frequency losses. The use of perfluorinated Fluorinert FC-87 enables efficient low temperature (near human or mammal body temperatures) cooling with an inert, safe, non-electrical conducting fluid through a combination of sensible heat increase and phase change (boiling).

Although the description above contains many details, these should not be construed as limiting the scope of the invention but as merely providing illustrations of some of the presently preferred embodiments of this invention.

Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A fluid cooled electromagnet apparatus, comprising:
an electromagnet that has a central region; and
means for cooling the electromagnet.

2. The apparatus of claim 1, wherein the means for cooling the electromagnet comprises:
a refrigerant that is forced through the electromagnet;
wherein the refrigerant is substantially a dielectric.

3. The apparatus of claim 1, wherein the refrigerant substantially comprises Fluorinert FC-87.

4. The apparatus of claim 1, wherein the means for cooling the electromagnet comprises:
a housing comprising:
an inlet that flows a refrigerant to the central region;
an outlet that receives refrigerant that has flowed through the electromagnet; and
a pressure vessel that entirely encloses the electromagnet, that opens to the inlet and outlet.

5. The apparatus of claim 4, wherein the pressure vessel does not substantially affect a magnetic field generated by the electromagnet when energized.

6. The apparatus of claim 4, wherein the pressure vessel has sufficient strength to contain a pressure of the refrigerant comprising:
an inlet pressure as the refrigerant enters the inlet;
a phase change pressure, generated as the refrigerant undergoes a phase change from liquid to gas through boiling heat transfer; and
an outlet backpressure as the refrigerant flows through the outlet.

7. The apparatus of claim 1, wherein the electromagnet is wound with a Litz wire to form an electromagnet coil winding.

8. The apparatus of claim 1, wherein the electromagnet coil winding is supported by a frame.

9. The apparatus of claim 1, wherein the electromagnet coil winding comprises multiple layers.

10. The apparatus of claim 1, wherein the electromagnet coil winding comprises multiple turns.

11. The apparatus of claim 7, wherein the electromagnet comprises:
a current source Iᵢₙ comprised of the Litz wire of which the electromagnet is wound; and
a current sink Iₒᵤₜ comprised of the Litz wire of which the electromagnet is wound.

12. The apparatus of claim 11, wherein the current source, current sink, and the electromagnet coil winding consist of the same uninterrupted continuous Litz wire.

13. The apparatus of claim 1, wherein the electromagnet is one of an array of fluid cooled electromagnets that can programmably direct magnetic fields into a human cranium.

14. The apparatus of claim 1, further comprising a non-ferromagnetic core.

15. The apparatus of claim 14, wherein the non-ferromagnetic core is an “air core”.

16. The apparatus of claim 1, further comprising a ferromagnetic core.

17. A method for transcranial magnetic stimulation, comprising:
providing an electromagnet coil;
flowing a dielectric refrigerant over the electromagnetic coil to cool the electromagnetic coil; and
directing a magnetic pulse from the electromagnet coil to a human cranium.

18. The method of claim 17, where the dielectric refrigerant is a fluorocarbon.

19. The method of claim 17, wherein the directing the magnetic pulse from the electromagnet coil to the human cranium step effects a transcranial magnetic stimulation.

20. A transcranial magnetic stimulator apparatus, comprising:
an electromagnet wound of a Litz wire;
a set of power leads that connect to the electromagnet comprised of he same Litz wire without splice or interruption; and
a perfluorocarbon in contact with the Litz wire for substantially the entire length of the Litz wire;
wherein the Litz wire is cooled by the perfluorocarbon when the electromagnet is energized.

21. The apparatus of claim 20, comprising:
an external cooling unit that cools the perfluorocarbon that is heated due to heat dissipated by the Litz wire when the electromagnet is energized.

22. The apparatus of claim 21, wherein the external cooling unit is a closed system that prevents loss of the perfluorocarbon.

23. The apparatus of claim 20, further comprising a computer controlled power supply that energizes the electromagnet with a waveform directed by a computer control.

24. The apparatus of claim 20, wherein the electromagnet may continuously produce an external directed magnetic field greater than 2 T without thermally induced damage.
